(19) United States
(12) Patent Application Publication
(10) Pub. No.: US 2025/0319846 A1
(43) Pub. Date: Oct. 16, 2025

(54) WIPER BLADE CONNECTION DEVICE

(71) Applicant: VALEO SYSTEMES D'ESSUYAGE, La Verriere (FR)

(72) Inventors: Stephane HOUSSAT, La Verriere (FR); Vincent GAUCHER, La Verrière (FR); Guillaume MOULEYRE, La Verrière (FR); Olivier JOMARD, La Verrière (FR)

(73) Assignee: VALEO SYSTEMES D'ESSUYAGE, La Verriere (FR)

(21) Appl. No.: 18/866,100

(22) PCT Filed: May 17, 2023
(86) PCT No.: PCT/EP2023/063403

§ 371 Date: Nov. 15, 2024

(30) Foreign Application Priority Data
May 19, 2022 (FR) 2204777

(51) Int. Cl. B60S 1/38

(52) U.S. Cl. CPC B60S 1/3849

(57) ABSTRACT

The present invention is a connection device for connecting a wiper blade extending in a longitudinal direction to an arm of a wiping system, the connection device including a connector configured to carry the wiper blade and a connection module adapted to be mounted on the connector and connected to the arm. The connection module including at least one base mounted pivotably about a pivot axis on the connector and a rotary platform mounted rotatably about a rotation axis on the base. The pivot axis and the rotation axis extending parallel to and separately from one another, the rotation axis being offset longitudinally relative to the pivot axis.

### TECHNICAL FIELD

The present invention relates to the field of wiping systems for automotive vehicles. More particularly, the present invention relates to the field of connection devices positioned between a wiper arm and a wiper blade of such wiping systems.

### BACKGROUND OF THE INVENTION

Automotive vehicles are commonly fitted with wiping systems for cleaning their glazed surfaces, and in particular their windshields. Such wiping systems comprise at least one wiper arm and a wiper blade driven by the wiper arm. The wiper arm is connected to an electric motor of the vehicle and the wiper blade comprises at least one wiper rubber intended to come into contact with the glazed surface to be wiped.

A connection device is arranged between this wiper blade and the wiper arm so that the wiper blade can be driven. More particularly, the connection device comprises an adapter arranged between the wiper arm and a connector attached to the wiper blade. The adapter is then rigidly secured to the wiper arm, and more particularly to a free end of the wiper arm, this interaction being detachable such that the wiper blade can be changed when it is worn.

However, different types of wiper arms are currently fitted to automotive vehicles, forcing automotive equipment manufacturers to design different adapters specific to each type of arm, with one adapter specifically connecting one type of wiper arm to one connector. This on the one hand pushes equipment manufacturers to develop many different adapters, with at least one for each type of wiper arm on the market, and on the other hand requires users who have to change their wiper blade to adapt and pay extra attention to choose the right adapter according to the type of wiper arm on which the wiper blade is to be mounted.

Document US 2012144615 discloses providing an adapter which comprises a base mounted pivotably on the connector and a rotary platform mounted rotatably on this base, with two pivot and rotation axes that are longitudinally offset relative to one other. Although it makes it possible to manage the attachment of a wiper blade to several types of wiper arms, in particular due to the possible attachment of wiper arms to the rotary platform or to the base, this configuration takes up a certain amount of space since it requires, on the one hand, a base that is wide enough to be able to retract the rotary platform into the volume of the base and, on the other hand, a base that is long enough to be able to offset the rotation pin of the rotary platform.

### SUMMARY OF THE INVENTION

The present invention falls within this context and has as main subject matter a connection module configured to be mounted pivotably about a pivot axis of a connector configured to be rigidly secured to a wiper blade extending in a longitudinal direction, the connection module being adapted to be connected to a wiper arm, the connection module comprising at least one base mounted pivotably on the connector and a rotary platform mounted rotatably about a rotation axis on the base, the pivot axis and the rotation axis extending parallel to and separately from one another, the rotation axis being offset longitudinally relative to the pivot axis, characterized in that the rotary platform has a longitudinal dimension substantially equal to the longitudinal dimension of the base.

The wiper blade and the wiper arm form part of a wiping system of a vehicle for at least partially cleaning a glazed surface of said vehicle. The wiping system more particularly comprises the wiper arm, an electric motor configured to rotate the arm and allow, as the blade moves as one with the arm via the connection device, a back and forth movement of the wiper blade along the glazed surface and cleaning of this glazed surface by a rubber borne by the wiper blade.

As mentioned, the connection device comprises a connection module mounted pivotably on a connector rigidly secured to the blade, this pivot axis allowing, in a known manner, the assembly formed by the connector and the wiper blade to pivot relative to the wiper arm so as to adapt the position of the wiper blade against the glazed surface to be wiped during the back and forth movement of the wiper blade.

According to the invention, the connection module is split into at least two rotary parts rotating relative to one another, namely the base which ensures the function of pivoting of the connection module relative to the connector, as mentioned above, and the rotary platform which is mounted movably relative to the base.

The longitudinal offset between the two parts of the connection module makes it possible to generate an angular movement of the platform relative to the base which is sufficient so that, in a position in which the platform is disengaged from the base, the platform can interact with different types of wiper arms independently of the base, the platform and the base being further configured to lock the position of these different types of wiper arms once the position of the platform is fixed relative to that of the base. A connection module according to the invention thus makes it possible to associate a wiper blade and an associated connection device with a multiplicity of different types of arms which can be connected to the connection device both when the rotary platform is pressed against the base and when the rotary platform is at a distance from the base.

In this context, as stated above, the longitudinal dimensions of the base and of the rotary platform are the same. The fact that a longitudinal dimension of the base is the same as that of the rotary platform makes it possible to limit the longitudinal bulk of the connection module, which is desirable for aerodynamic reasons when the wiping system formed by the blade and the wiper arm is mounted on an automotive vehicle, and the fact that a longitudinal dimension of the rotary platform is the same as that of the base makes it possible to ensure sufficient disengagement of the free end of the rotary platform, in its mounting position, to be able to attach to the rotary platform, or to insert between the rotary platform and the base, types of wiper arms with various profiles and dimensions.

According to an optional feature of the invention, the connector comprises two segments extending parallel to one another and protruding from an upper face of the connector, the two segments helping to delimit at least in part a housing for the base, each segment extending a side wall of the connector.

According to another optional feature of the invention, at least one of the two segments comprises a pivot element, the base comprising at least one pivot member intended to interact with the pivot element in such a way as to form a pivot device between the connector and the base.

According to an optional feature of the invention, the rotation axis is formed at one of the longitudinal ends of the base. Positioning the rotation axis at a longitudinal end thus makes it possible to optimize the movement of the rotary platform relative to the base. According to a feature of the invention, the rotation axis is formed at one of the longitudinal ends of the base while the pivot axis is formed substantially at the center of this base.

According to another optional feature of the invention, the base comprises a rotation member adapted to interact with the rotary platform and a guide block intended to receive a free end of the rotary platform, the base extending longitudinally while having a first longitudinal end in the vicinity of which the guide block is arranged and a second longitudinal end in the vicinity of which the rotation member is arranged. In other words, the guide block and the rotation member are each arranged at an opposite longitudinal end of the base.

According to another optional feature of the invention, the rotary platform is movable between a first working position in which the rotary platform is received in the guide block of the base and a second mounting position in which the free end of the rotary platform is arranged at a distance from the guide block. Considering a plane perpendicular to the rotation axis, the rotational movement of the platform relative to the base is such that, when the rotary platform is in the first working position, it extends mainly in a direction parallel to the longitudinal direction, and parallel to the main direction of extension of the base, whereas, when the rotary platform is in the second mounting position, it extends in a direction intersecting the longitudinal direction and the main direction of extension of the base. As mentioned above, this mobility of the rotary platform allows certain types of arms to be mounted on the connection device when the rotary platform is in the first working position, and other types of arms to also be mounted on the connection device when the rotary platform is in the second mounting position.

According to another optional feature of the invention, a main axis of extension of the rotary platform forms, with a main axis of extension of the base when the rotary platform is in the second mounting position, an angle of inclination of between 30° and 60°.

According to an optional feature of the invention, the rotary platform comprises a positioning member at one of its longitudinal ends, configured to bear on the connector when the rotary platform is in the second mounting position in such a way as to position the connection module in an angular position suitable for mounting a type of wiper arm.

More particularly, the positioning member extends longitudinally from the longitudinal end of the rotary platform which is arranged in the vicinity of the rotation member, and opposite its free end.

This positioning member facilitates and thus ensures the mounting of a type of wiper arm on the rotary platform of the connection module.

When the rotary platform is in the second mounting position, the positioning member bears on the connector, creating a force which in turn pivots the base forward.

According to an optional feature of the invention, the positioning member is in the form of a prop.

According to another optional feature of the invention, the base comprises a frame comprising at least two longitudinal walls extending in the longitudinal direction between the first longitudinal end and the second longitudinal end parallel to one another, the frame further comprising two transverse walls extending perpendicularly and between the longitudinal walls, a first transverse wall being arranged at the first longitudinal end of the structure and facing the guide block while the second transverse wall is arranged at the second longitudinal end and bears the rotation member.

According to another optional feature of the invention, at least one longitudinal wall bears the pivot member interacting with the pivot element of the connector.

According to another optional feature of the invention, the pivot member comprises a tab delimited longitudinally by at least one vertical slot formed in the longitudinal wall, the tab bearing a peg extending transversely toward the outside of the base.

According to another optional feature of the invention, the tab is elastically deformable around a bending axis parallel to the longitudinal direction.

According to another optional feature of the invention, the longitudinal walls each have a notch extending longitudinally on an upper edge of the longitudinal wall.

According to another optional feature of the invention, the base comprises at least one reinforcing bridge connecting the upper edges of the two longitudinal walls in a transverse direction parallel to the pivoting direction.

According to another optional feature of the invention, the reinforcing bridge has a transverse dimension that is greater than the transverse dimension between the two longitudinal walls, such that the two transverse ends of the reinforcing bridge extend transversely beyond the longitudinal walls.

According to another optional feature of the invention, the base comprises a first reinforcing bar and a second reinforcing bar extending transversely between the two lower edges of the longitudinal walls on either side of the pivot member.

According to another optional feature of the invention, the guide block comprises two lateral segments extending parallel to one another each from one of the longitudinal walls opposite the connector, and the guide block comprises at least one recess formed on an internal face of one of the lateral segments and adapted to interact with the rotary platform.

According to another optional feature of the invention, the connection device comprises a cap mounted to pivot about a pivoting axis parallel to the pivot axis and formed at a longitudinal end of the base opposite the longitudinal end where the rotation axis is formed.

According to another optional feature of the invention, the guide block comprises a first recess interacting with the rotary platform and a second recess interacting with the cap, each of the recesses being arranged on the internal face of the lateral segment.

According to another optional feature of the invention, the base comprises a pivoting member for pivoting with the cap such that the cap is movable between a covering position in which the cap is in contact with the guide block and a release position in which the cap is at a distance from the guide block, the pivoting member comprising at least one shaft protruding transversely from the base at the first longitudinal end.

According to another optional feature of the invention, the guide block comprises a means for stopping the cap as it pivots about the pivoting direction, blocking the cap in the release position.

According to another optional feature of the invention, the lateral segments of the guide block are symmetrical to one another with respect to a median plane of the base perpendicular to the pivot axis.

According to another optional feature of the invention, the base comprises at least one protrusion arranged at the second longitudinal end of the base, the protrusion protruding from the first transverse wall in the opposite direction to the connector, the rotation member taking the form of a shaft carried by the protrusion and extending transversely beyond the protrusion.

According to another optional feature of the invention, the base comprises a means for limiting rotation of the rotary platform about the rotation axis, the rotation limiting means being arranged at the free end of the protrusion.

According to another optional feature of the invention, the base comprises at least one force take-up means which protrudes from a longitudinal wall and of which at least one offset part extends in a plane parallel to and distinct from the plane in which said longitudinal wall is inscribed, the base being configured such that the longitudinal wall and the offset part are arranged transversely on either side of a segment of the connector.

According to another optional feature of the invention, the rotary platform comprises a body extending in the longitudinal direction between a free end configured to interact with the guide block and a longitudinal edge on which there is a rotation element for rotation of the rotary platform about the rotation axis.

According to another optional feature of the invention, the body comprises an upper surface intended to be facing the wiper arm intended to be attached to the connection device, a lower surface intended to be facing the base and two lateral flanks extending between the upper surface and the lower surface, the rotary platform comprising a bore forming a bearing for receiving a rod of a wiper arm extending transversely and being open on at least one of the lateral flanks.

According to another optional feature of the invention, at least one of the lateral flanks of the rotary platform comprises a retention means for retaining a protruding element formed on a yoke of a type of wiper arm and more particularly a protruding element formed on an internal face of a yoke of a type of wiper arm.

According to another optional feature of the invention, the retention means is arranged on at least one of the lateral flanks of the rotary platform, preferably both, between the pivot axis and the rotation axis.

Preferably, the retention means is arranged on at least one of the lateral flanks of the rotary platform in the vicinity of the pivot axis.

According to another optional feature of the invention, the retention means comprises at least two walls configured to retain the protruding element of the yoke of a type of wiper arm.

Alternatively, the retention means comprises a slot configured to receive the protruding element of the yoke of a type of wiper arm.

According to another optional feature of the invention, the rotation element comprises two rotation lugs, each extending one of the lateral flanks toward the base, each rotation lug comprising a hole passing transversely through the rotation lug and configured to interact with the rotation member of the base.

According to another optional feature of the invention, the rotary platform comprises a guide wall extending between the rotation lugs of the rotation element, in a plane parallel to and distinct from that in which the upper surface of the rotary platform extends.

According to another optional feature of the invention, the guide wall has a stop edge adapted to interact with the rotation limiting means of the base to limit the rotation of the rotary platform about the rotation axis.

According to another optional feature of the invention, the rotary platform comprises attachment areas for attaching a removable adapter.

According to another optional feature of the invention, the rotary platform comprises a window delimited by the guide wall and the body of the rotary platform, the window being intended to receive a hook of the removable adapter.

According to another optional feature of the invention, the free end of the rotary platform comprises a first flank extending one of the lateral flanks in the direction away from the rotation element and a second flank extending the other lateral flank in the direction away from the rotation element parallel to the first flank, the first flank and the second flank defining a housing for receiving a wiper arm.

According to another optional feature of the invention, at least one of the first and/or second flanks comprises an elastically deformable tab having a finger extending into the housing for receiving the wiper arm.

According to another optional feature of the invention, at least one of the lateral flanks comprises a bearing member having a bearing edge extending the bearing member toward the base, the body of the rotary platform being intended to bear on one of the notches of the base via one of the bearing members of the lateral flank.

According to another optional feature of the invention, when the rotary platform is in the first working position, the bearing member of the lateral flank and the notch of the upper edge of the longitudinal wall help to define an opening helping to immobilize a type of wiper arm in position relative to the connection module.

According to another optional feature of the invention, one of the attachment areas for attaching the removable adapter is arranged on the body of the rotary platform, the attachment area taking the form of an indent arranged on the lateral flank of the body.

According to another optional feature of the invention, the rotary platform comprises a pair of adapter attachment areas, the attachment areas being symmetrical to one another with respect to a median plane of the rotary platform perpendicular to the direction of rotation.

According to another optional feature of the invention, the rotary platform comprises a reinforcing element extending from the lower surface of the body toward the base, the reinforcing element having a U-shaped section seen in a plane parallel to the longitudinal direction and to the rotation axis, the reinforcing element being intended to form a stop for one end of a wiper arm.

According to another optional feature of the invention, the rotation axis is offset vertically relative to the pivot axis.

According to another optional feature of the invention, the rotary platform comprises a system for attaching a covering member.

The present invention also relates to a connection device for connecting a wiper blade extending in a longitudinal direction to a wiper arm of a wiping system, the connection device comprising a connector configured to be rigidly secured to the wiper blade and a connection module adapted to be mounted on the connector and connected to the wiper arm, the connection module comprising at least one base mounted pivotably about a pivot axis on the connector and a rotary platform mounted rotatably about a rotation axis on the base, the pivot axis and the rotation axis extending parallel to and separately from one another, the rotation axis being offset longitudinally relative to the pivot axis, characterized in that the rotary platform has a longitudinal dimension substantially equal to the longitudinal dimension of the base.

The present invention also relates to a connection device for connecting a wiper blade extending in a longitudinal direction to a wiper arm of a wiping system, the connection device comprising a connector configured to be rigidly secured to the wiper blade and a connection module adapted to be mounted on the connector and connected to the wiper arm, the connection module comprising at least one base mounted pivotably about a pivot axis on the connector and a rotary platform mounted rotatably about a rotation axis on the base and movable between a working position and a release position, the pivot axis and the rotation axis extending parallel to and separately from one another, the rotation axis being offset longitudinally relative to the pivot axis, characterized in that the platform is at least partially disengaged from the base in the working position.

In other words, the connection module according to the invention comprises a rotary platform mounted on a pivoting base, and the rotary platform rests at least partly against an upper edge of a wall of the pivoting base so as to form between the platform and the base means for attaching a type of wiper arm.

The base comprises a guide block which protrudes from the upper wall at the end opposite the rotation axis, for receiving the free end of the rotation platform and locking the latter while it rests on the upper edge of a wall of the base. Such a configuration, in which the platform is not completely retracted into the base when it takes up its working position, makes it possible both to use the platform as a means for locking a wiper arm between the base and the platform and to use this platform, as regards the disengaged part, to form a support for a removable adapter or a covering member of the connection module.

The present invention also relates to a wiper blade comprising a wiper rubber and a connection module according to any of the above features.

Lastly, the present invention relates to a wiping system comprising at least a wiper arm and a wiper blade according to the above feature, the wiper blade being arranged at one end of the wiper arm, the wiper arm being rigidly secured to the wiper blade by interaction with the connection module.

### BRIEF DESCRIPTION OF DRAWINGS

Other features, details and advantages of the invention will become clearer on reading the description of several embodiments provided by way of non-limiting indication, with reference to the appended schematic drawings, in which:

FIG. 1 is a perspective illustration of a wiper blade on which a connection device according to the invention is mounted;

FIG. 2 is an exploded view of the wiper blade and the connection device shown in FIG. 1;

FIG. 3 is a perspective view of a connector, a connection module comprising a base and a rotary platform, and a cap, forming the connection device shown in FIG. 1;

FIG. 4 is a perspective view of the connection module and the cap shown in FIG. 3, in which the rotary platform is in a mounting position;

FIG. 5 is a perspective illustration of the connector shown in FIG. 3;

FIG. 6 is a perspective view from above of the base shown in FIG. 3;

FIG. 7 is a perspective view from below of the base shown in FIG. 3;

FIG. 8 is a perspective view from above of the rotary platform shown in FIG. 3;

FIG. 9 is a perspective view from below of the rotary platform shown in FIG. 3;

FIG. 10 is a longitudinal section of the connection device shown in FIG. 1 and mounted on a first type of wiper arm;

FIG. 11 is a perspective illustration of the connection device shown in FIG. 1 and mounted on a second type of wiper arm;

FIG. 12 is a perspective illustration of the connection device shown in FIG. 1 and mounted on a third type of wiper arm;

FIG. 13 is a perspective illustration of the connection device shown in FIG. 1 and mounted on a fourth type of wiper arm.

The features, variants and different embodiments of the invention may be combined with one another in various combinations, provided that they are not mutually incompatible or exclusive. In particular, variants of the invention may be imagined comprising only a selection of features described hereinafter in isolation from the other features described, if this selection of features is sufficient to confer a technical advantage and/or to differentiate the invention from the prior art.

### DETAILED DESCRIPTION OF THE INVENTION

In the figures, elements that are common to multiple figures retain the same reference sign.

In the following detailed description, the terms “longitudinal”, “transverse” and “vertical” refer to the orientation of a wiping system according to the invention. A longitudinal direction corresponds to a main direction of extension of a wiper blade of the wiping system, this longitudinal direction being parallel to a longitudinal axis L of a reference system L, V, T shown in the figures. A vertical direction corresponds to a direction of stacking of a connector, a base and a rotary platform of a connection device of the wiping system, with this vertical direction being parallel to a vertical axis V of the reference system L, V, T, and this vertical axis V being perpendicular to the longitudinal axis L. Lastly, a transverse direction corresponds to a direction parallel to a transverse axis T of the reference system L, V, T, with this transverse axis T being perpendicular to the longitudinal axis L and to the vertical axis V.

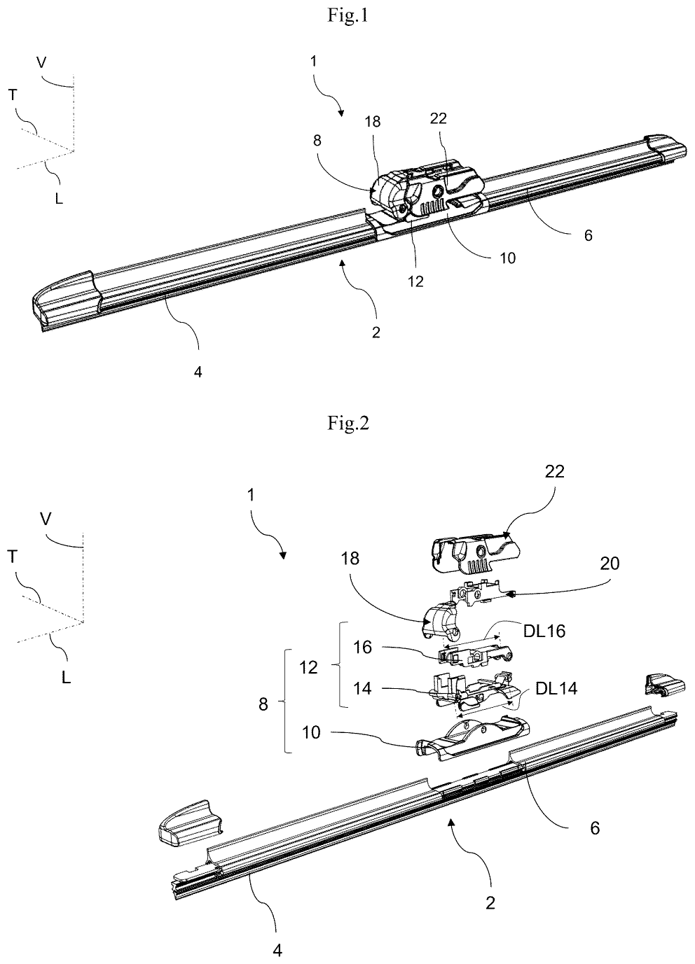

FIG. 1 shows a wiping system 1 configured for cleaning a glazed surface of a vehicle, for example a windshield, so as to improve a driver's view of the road in front of the vehicle. The wiping system 1 comprises at least one wiper arm, not shown in FIG. 1, bearing at one end a wiper blade 2 which extends mainly in the longitudinal direction L.

The wiper blade 2 comprises at least one wiper rubber 4, intended to be in contact with the glazed surface to be cleaned, and a holder 6 for said wiper rubber 4.

The wiper blade 2 is also rigidly secured to the wiper arm by a connection device 8. The connection device 8 according to the invention comprises a connector 10 and a connection module 12 mounted pivotably on the connector 10, the latter being rigidly secured to the wiper blade 2 while the connection module 12 is configured to be rigidly secured to the wiper arm of the wiping system 1.

The pivotable mounting of the connection module 12 on the connector 10 thus allows the wiper blade 2 to pivot at one of the ends of the wiper arm and thus ensure that the wiper rubber 4 is pressed onto the glazed surface to be wiped.

More particularly, and as shown in FIG. 2 to FIG. 4, the connection module 12 comprises a base 14 mounted pivotably about a pivot axis P on the connector 10, and a rotary platform 16 mounted rotatably about a rotation axis R on the base 14.

In other words, the connection device 8 comprises three members, namely the connector 10, the base 14 and the rotary platform 16, articulated in pairs so as to allow, on the one hand, pivoting of the connector 10, and by extension the wiper blade 2, relative to the connection module 12 and, on the other hand, mounting of different types of wiper arms on the connection module 12.

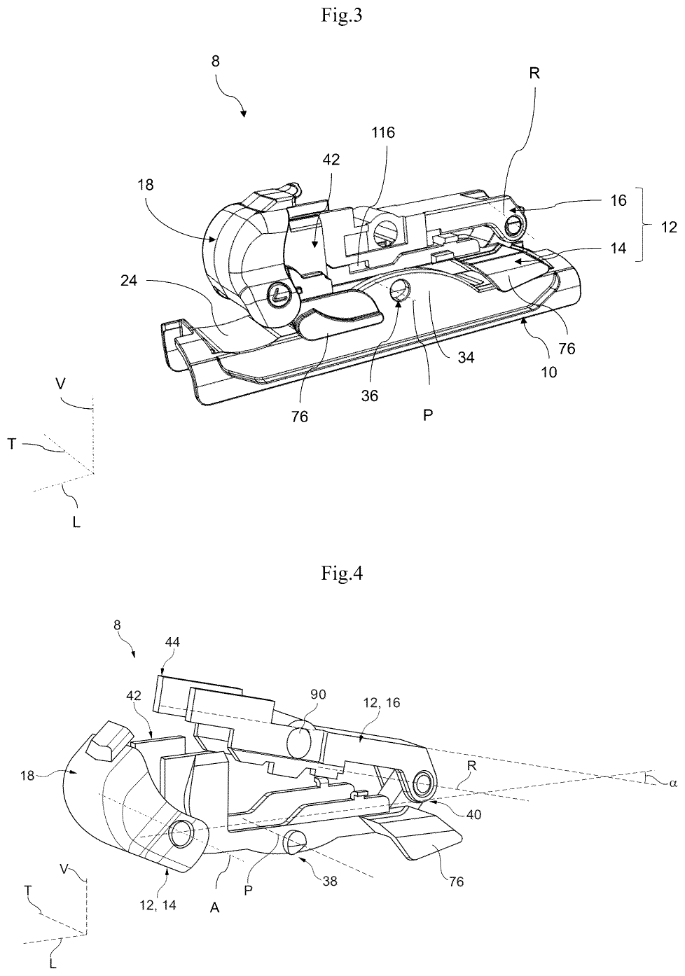

As can be seen more particularly in FIG. 3, the pivot axis P and the rotation axis R extend parallel to and separately from one another. In the example illustrated, the pivot axis P is formed substantially at the center of the base 14, relative to the longitudinal dimension of this base, and the rotation axis R is offset longitudinally. This longitudinal offset of the rotation axis relative to the pivot axis P allows the rotary platform to swivel into a mounting position which is inclined relative to the longitudinal and transverse plane of the base, the swivelling of this rotary platform allowing mounting of certain types of wiper arm on this connection device 8. Advantageously, the pivot axis P and the rotation axis R are offset vertically relative to one another.

According to the invention, and as will be described in more detail below, the base and the rotary platform have an equivalent longitudinal dimension relative to one another. As a result, the longitudinal bulk of the connection module is optimized and corresponds to the useful longitudinal dimension of the rotary platform, the base not having any end portions extending beyond the rotary platform.

Furthermore, as shown in the figures, the rotation axis R and the means implemented to generate this rotation of the rotary platform are arranged at one of the longitudinal ends of the base 14 such that this, together with the equivalent longitudinal dimension of the rotary platform relative to the base, allows optimal movement of the rotary platform so that it can take up a mounting position in which the wiper arms are easily put in place on the platform.

As can be seen in particular in FIG. 2 and FIG. 4, the connection device 8 comprises a cap 18 mounted so as to be pivotably movable about a pivoting axis A, parallel to the pivot axis P and to the rotation axis R. The pivoting axis A is formed at a longitudinal end of the base 14 which is opposite the longitudinal end where the rotation axis R is formed. The cap 18 is configured to be movable between a covering position, attaching certain types of wiper arm to the connection device 8, and a release position allowing mounting of certain types of wiper arm on the connection device 8.

The connection device 8 may also comprise, as can be seen in FIG. 2, a removable adapter 20 configured to be attached to the rotary platform 16 and allow interaction between the connection device 8 and certain types of wiper arm which cannot be attached directly to the rotary platform.

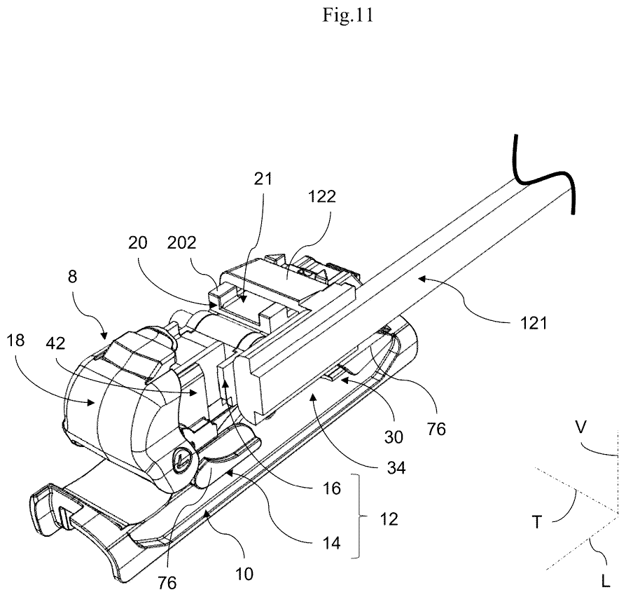

To this end, this removable adapter 20 comprises snap-fit attachment means adapted to interact with the rotary platform, and it further comprises means for wedging certain types of wiper arm, including studs 202, visible in FIG. 11, delimiting between them both longitudinal and transverse wedging paths, the transverse path being able in particular to allow the positioning of a retention tab 122 of a type of wiper arm, and/or at least one locking tongue 204, partially visible in FIG. 13, against which another type of wiper arm is arranged.

In this example, as can be seen more particularly in FIG. 2, the connection device 8 may comprise a covering member 22 rigidly secured to the rotary platform 16 and/or the base 14 and at least partially covering the connector 10, the rotary platform 16 and/or the base 14. The covering member 22 allows interaction between the connection device 8 and certain types of wiper arm.

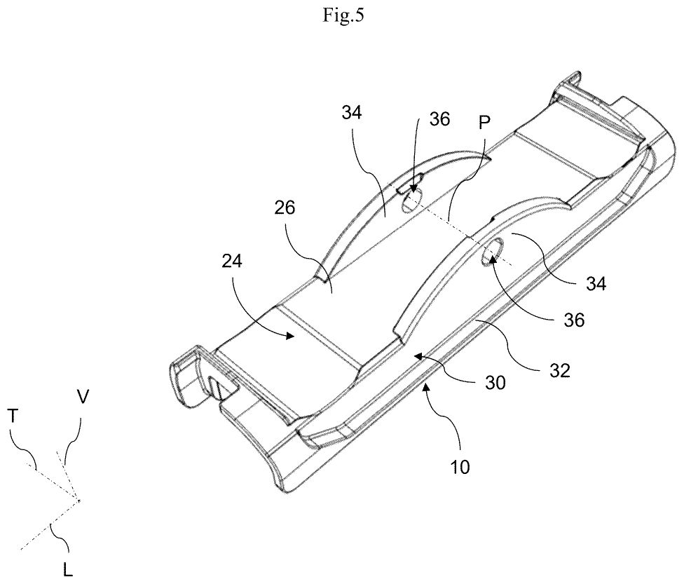

Each of the elements making up the connection device 8 will now be described in greater detail, starting with the connector 10 with reference to FIG. 2 to FIG. 5.

The connector 10 has a main wall 24 extending substantially parallel to the longitudinal L and transverse T directions, the main wall 24 having an upper face 26 facing the connection module 12 and a lower face 28 facing the wiper blade 2. More particularly, the lower face 28 of the main wall 24 helps to delimit a housing of the blade and in particular the holder 6 for the wiper rubber 4.

The connector 10 comprises two side walls 30 extending at each of the transverse ends of the main wall 24, each of the side walls 30 being inscribed in a plane substantially parallel to the longitudinal L and vertical V directions. The side walls 30 each have a clearance 32 on their external face, each clearance 32 being formed by a removal of material from the upper edge of the corresponding side wall and extending longitudinally between the two longitudinal ends of the connector 10.

The connector 10 comprises two segments 34 which extend parallel to one another and protrude from the upper face 26 of the upper wall, each segment 34 extending a side wall 30 of the connector 10. These two segments 34, which extend on the opposite side to the lower face 28 of the main wall 24, help to at least partially delimit a housing for the base 14. The segments 34 each have a convexly curved free end, and are symmetrical to one another with respect to a median plane of the connector 10 parallel to the longitudinal L and vertical V directions.

At least one of the two segments 34 comprises a pivot element 36 adapted to interact with a pivot member 38 of the base 14 in such a way as to form a pivot device between the connector 10 and the base 14. Preferably, each of the two segments 34 comprises a pivot element 36 interacting with a corresponding pivot member 38 of the base 14, the holes of the pivot elements 36 being aligned in the transverse direction T.

The pivot element 36 here takes the form of a hole made in the segment 34, in this case a hole passing transversely through the segment 34, while the pivot member 38 takes the form of a peg intended to extend at least partially into the hole. The interaction between the hole and the peg thus forms the pivot device.

The pivot element 36 is in this case arranged at the center of the segment 34 in the longitudinal direction L, that is to say that it is arranged equidistant from each of the longitudinal ends of the segment 34 in the longitudinal direction L. The centered arrangement of the pivot element 36 makes it possible in particular to balance the pivoting of the wiper blade 2 relative to its arrangement at the end of the wiper arm.

As mentioned above, the connection module 12 comprises the base 14 and the rotary platform 16 mounted rotatably on this base 14, the longitudinal dimensions of each of these components being specific to the invention.

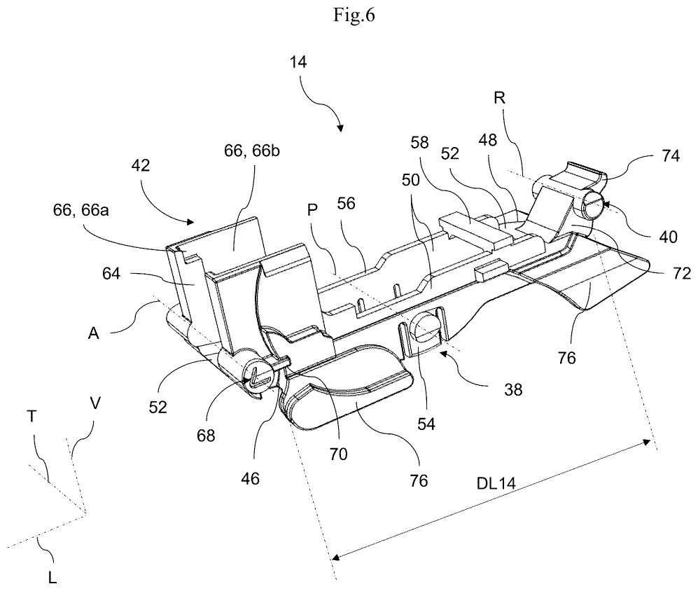

The base 14 comprises a rotation member 40 adapted to interact with the rotary platform 16 in order to allow the platform to rotate relative to the base 14 about the rotation axis R, and a guide block 42 intended to receive a free end 44 of the rotary platform 16. The base 14 extends longitudinally, having a first longitudinal end 46 in the vicinity of which the guide block 42 is arranged, and a second longitudinal end 48 in the vicinity of which the rotation member 40 is arranged. The base 14 thus has a longitudinal dimension DL14 measured between the first longitudinal end 46 and the second longitudinal end 48, as can be seen in FIG. 6.

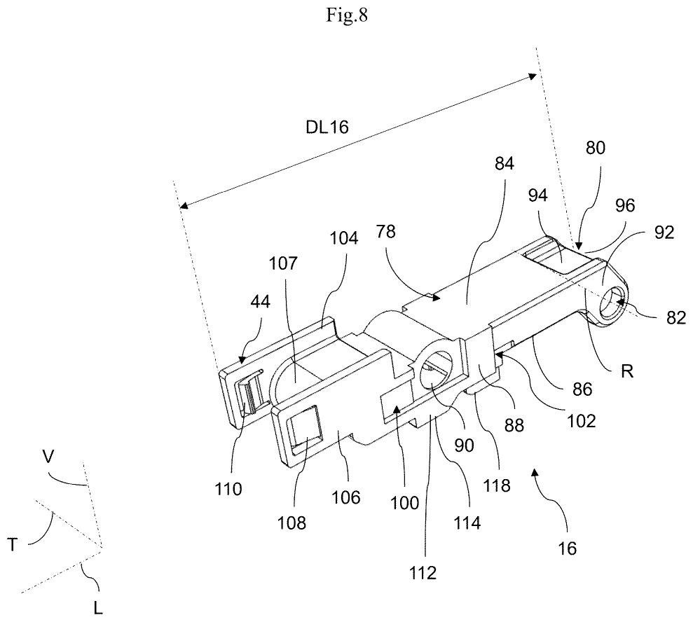

The rotary platform 16 comprises a body 78 extending in the longitudinal direction L between a free end 44 configured to interact with the guide block 42 and a longitudinal edge 80 on which there is a rotation element 82 for rotation of the rotary platform 16 about the rotation axis R. The rotary platform 16 thus has a longitudinal dimension DL16 measured between the free end 44 and the longitudinal edge 80, as can be seen in FIG. 8.

According to the invention, the platform has a longitudinal dimension DL16 which is substantially equal to the longitudinal dimension DL14 of the base. Thus, the free end 44 of the rotary platform may be facing the first longitudinal end 46 of the base when the longitudinal edge 80 of the rotary platform is facing the second longitudinal end 48 of the base.

The guide block 42 is intended to receive, in addition to the free end 44 of the rotary platform 16, a particular type of wiper arm and thus help to rigidly secure it to the connection module 12. The rotation member 40, for its part, allows the rotation of the rotary platform 16 between a first position in which the free end 44 of the rotary platform 16 is arranged in the guide block 42, and a second position in which the free end 44 of the rotary platform 16 is arranged at a distance from the guide block 42.

In other words, the rotary platform 16 is movable between a first working position, shown in FIG. 3, in which the rotary platform 16 is received in the guide block 42 of the base 14 and a second mounting position, shown in FIG. 4, in which the free end 44 of the rotary platform 16 is arranged at a distance from the guide block 42.

These two positions of the rotary platform may in particular be defined in a plane perpendicular to the rotation axis R, that is to say a plane parallel to the longitudinal L and vertical V directions. When the rotary platform 16 is in the first working position, the main axis of extension of said rotary platform 16 is parallel to the main axis of extension of the base 14, in this case the longitudinal axis L. When the rotary platform 16 is in the second mounting position, the main axis of extension of said rotary platform 16 and the main axis of extension of the base 14 are intersecting.

As can be seen in FIG. 4, the main axis of extension of the rotary platform 16 forms an angle of inclination α with the main axis of extension of the base 14 when the rotary platform 16 is in the second mounting position, the angle of inclination α having a value between 25° and 45° and which may more particularly be around 30°.

This angular inclination value has the advantage of separating the rotary platform 16 from the base 14 sufficiently to allow the mounting of certain types of arm on the connection device 8, this angular inclination making it possible to avoid contact between the connector and the underside of the arm when the latter is assembled to the connection device, bearing in mind the geometric disparities that may exist for the same type of arm depending on the equipment manufacturer that manufactures it.

Therefore, the invention makes it possible to obtain optimal angular separation within a reduced bulk of the rotary platform relative to the base, in particular owing to the equivalent longitudinal dimensions of these two components, and also owing to the articulation of the rotary platform on the base, offset at one longitudinal end of the base.

Note here that the rotary platform 16 is in the first working position when a wiper arm is mounted in the connection device 8, whereas it is in the second mounting position when it is necessary to assemble or disassemble a wiper arm to/from the blade and the associated connection device 8.

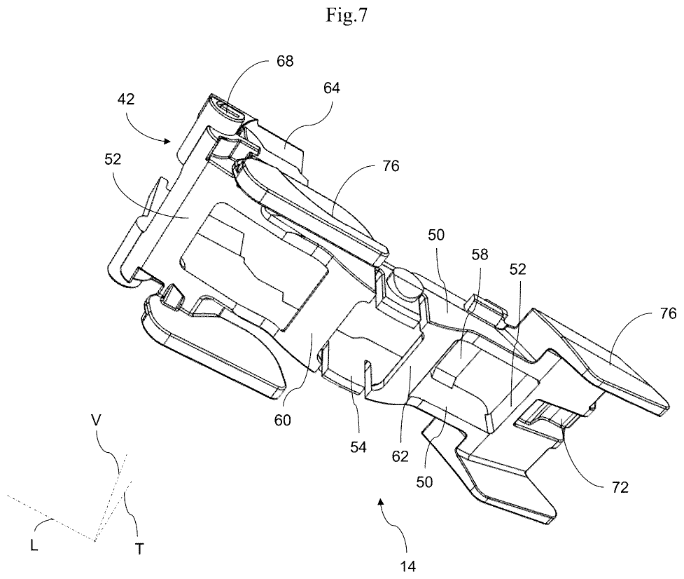

First, the base 14 will be described in greater detail with reference to FIG. 2, FIG. 3, FIG. 4, FIG. 6 and FIG. 7.

The base 14 comprises a frame comprising at least two longitudinal walls 50 extending in the longitudinal direction L between the first longitudinal end 46 and the second longitudinal end 48 parallel to one another, and two transverse walls 52 extending perpendicularly and between the longitudinal walls 50, a first transverse wall 52 being arranged at the first longitudinal end 46 of the structure and facing the guide block 42 while the second transverse wall 52 is arranged at the second longitudinal end 48 and bears the rotation member 40. In other words, the transverse walls 52 extend parallel to the transverse direction T, in such a way as to form with the longitudinal walls 50 the frame bearing at least the guide block 42 and the rotation member 40.

At least one longitudinal wall 50 bears the abovementioned pivot member 38 which is configured to interact with the pivot element 36 of the connector 10. Note that the peg of the pivot member 38 extends toward the outside of the longitudinal wall 50 bearing it, i.e. away from the other longitudinal wall, in order to interact with the hole of the pivot element 36 borne by the corresponding segment 34 of the connector 10.

More specifically, the pivot member 38 comprises a tab 54 delimited longitudinally by at least one vertical slot formed in the longitudinal wall 50, the tab 54 bearing the peg extending transversely toward the outside of the base 14. The tab 54 extends mainly in the vertical direction V, such that a bending axis of the tab 54 extends parallel to the longitudinal direction L. The bending of the tab 54 allows the mounting of the base 14 on the connector 10, the tab 54 being movable about the bending axis during the mounting of the base 14 on the connector 10 so as to return to its initial position once the peg extends at least partially into the hole in the segment 34.

The longitudinal walls 50 are spaced apart from one another such that they extend between the segments 34 of the connector 10 when the base 14 is attached to the connector by clip mounting, the base 14 extending at least partially into the housing defined by the segments 34 of the connector 10 as described above.

Furthermore, the longitudinal walls 50 each have a notch 56 extending longitudinally on an upper edge of the longitudinal wall 50.

As can be seen more particularly in FIG. 6 and FIG. 7, the base 14 comprises at least one reinforcing bridge 58 connecting the upper edges of the two longitudinal walls 50 in the transverse direction T parallel to the pivot axis P. The reinforcing bridge 58 makes it possible to stiffen the frame of the base 14, in particular to ensure that the two longitudinal walls are spaced apart from one another and to ensure that the pegs forming the pivot member 38 remain engaged in the holes forming the pivot element 36 even when transverse forces are applied to the connection module 12 by the wiper arm. Moreover, the reinforcing bridge 58 has a transverse dimension that is greater than the transverse dimension between the two longitudinal walls, such that the two transverse ends of the reinforcing bridge extend transversely beyond the longitudinal walls 50.

Advantageously, the base 14 comprises a first reinforcing bar 60 and a second reinforcing bar 62, shown in FIG. 7 and extending transversely between the two lower edges of the longitudinal walls 50 on either side of the pivot member 38. The reinforcing bars 60, 62 have a function similar to that of the reinforcing bridge 58 extending over the upper edges of the longitudinal walls 50, that is to say stiffening of the frame of the base 14 in order to limit deformation of said frame when the connection device 8 is subjected to transverse forces.

The guide block 42, arranged at the first longitudinal end 46 of the base, comprises two lateral segments 64 extending parallel to one another, each in the vertical extension of one of the longitudinal walls 50, in the opposite direction to the connector 10. The lateral segments 64 help in particular to delimit a housing for the free end 44 of the rotary platform 16 when the latter is in the first working position.

The guide block 42 comprises at least one recess 66 formed on an internal face of one of the lateral segments 64. Preferably, each of the internal faces of the lateral segments 64 has a recess 66. At least one recess helps to form a hollow for receiving the free end 44 of the rotary platform 16.

More particularly, in the example illustrated, the guide block 42 comprises, on at least one of the lateral segments, in this case both, a first recess 66a interacting with the cap 18 and a second recess 66b interacting with the rotary platform 16, each of the recesses 66a, 66b being positioned on the internal face of the corresponding lateral segment 64. Note in this case that the second recess 66b is configured to interact with the free end 44 of the rotary platform 16 when the latter is in its working position, while the first recess 66a is configured to interact with the cap 18 to block the latter in the covering position, thus fixing at least the position of the rotary platform 16, and advantageously the position of a wiper arm.

According to the example shown in particular in FIG. 6, the first recess 66a and the second recess 66b are in communication with one another such that they form just a single recess 66 having two zones, one of which interacts with the rotary platform 16 while the other interacts with the cap 18, but it should be noted that the first recess and the second recess could be made separately from one another without departing from the context of the invention.

Also, the base 14 comprises a pivoting member 68 adapted to interact with a pivoting element of the cap 18 in such a way as to form a pivoting device between the base and the cap about the pivoting axis A. The cap 18 is thus movable between a covering position in which the cap 18 is in contact with the guide block 42, at least partially covering the housing for the free end 44 of the rotary platform 16 and an end of a wiper arm attached to the connection device, and a release position in which the cap 18 is at a distance from the guide block 42 so as to allow in particular the mounting of a wiper arm on the rotary platform in its mounting position. In this case, the pivoting element of the cap is a hole, and the pivoting member 68 comprises at least one shaft forming a transverse protrusion from the base 14 in the vicinity of the first longitudinal end 46.

A stop means 70 is associated with the pivoting member 68, for stopping the cap 18 as it pivots about the pivoting axis A and blocking the cap 18 in its release position. The stop means 70 for example in this case takes the form of a pin extending from an external face of one of the lateral segments 64 in the transverse direction T.

As shown, the lateral segments 64 may be symmetrical to one another with respect to a median plane of the base 14 perpendicular to the pivot axis P.

At the second longitudinal end 48, the base 14 comprises at least one protrusion 72 protruding from the first transverse wall 52 in the opposite direction to the connector 10, in particular to carry the rotation member 40 mentioned above and vertically offset this rotation member 40 relative to the pivot member 38. The rotation member 40 in this case takes the form of a shaft carried by the protrusion 72 and extending transversely on either side to form two bearing surfaces adapted to interact with a rotation element of the rotary platform. The protrusion 72 extends more particularly from the transverse wall 52 mainly in the transverse direction T, away from the connector 10. As mentioned, in this configuration the shaft is offset at least vertically relative to the frame of the base 14, thereby allowing the rotary platform 16 sufficient space to be able to be rotated about the rotation axis R.

The base 14 comprises a means for limiting rotation 74 of the rotary platform 16 about the rotation axis R, the rotation limiting means 74 being arranged at the free end of the protrusion 72. The rotation limiting means 74 thus makes it possible to block the rotation of the rotary platform 16 in the second mounting position, the rotation limiting means 74 taking the form, for example, of a stop finger.

The base 14 also comprises at least force take-up means 76 configured to allow the transmission of transverse forces, that is the forces to which the connection device is subjected parallel to the direction of pivoting of the connection module 12 relative to the connector 10. At least first force take-up means are borne by one of the longitudinal walls

More particularly, the force take-up means 76 are characterized in that a part, more specifically referred to as a bearing portion hereinafter, is arranged facing the corresponding longitudinal wall 50 so as to transversely flank a wall of the connector, and in particular a segment of the connector. The part of the force take-up means facing the longitudinal wall extends in a plane parallel to the planes in which the longitudinal walls 50 are respectively inscribed, the force take-up means 76 forming a protrusion from the corresponding longitudinal wall, extending vertically away from the upper edge of this longitudinal wall. Preferably, the base 14 comprises a pair of force take-up means 76 extending on either side of the base 14, each of the force take-up means 76 comprising a bearing portion extending in a plane parallel to the longitudinal walls 50 and at a distance from the latter, delimiting a housing for a segment 34 of the connector 10.

As shown in FIG. 3 for example, the base 14 is configured such that a longitudinal wall 50 and the force take-up means 76 which form a protrusion from this longitudinal wall are arranged transversely on either side of a segment 34 of the connector 10. In other words, at least one segment 34, in this case each of the segments 34, is flanked transversely on the one hand by one of the longitudinal walls 50 and on the other hand by force take-up means 76 of the base 14, and more specifically a bearing portion of these force take-up means. By virtue of this flanking, the longitudinal wall 50 or the force take-up means 76 are brought into contact with the connector 10, in the direction of a force exerted transversely on the connector 10, and thus allow the transverse forces to be taken up regardless of the direction of the forces.

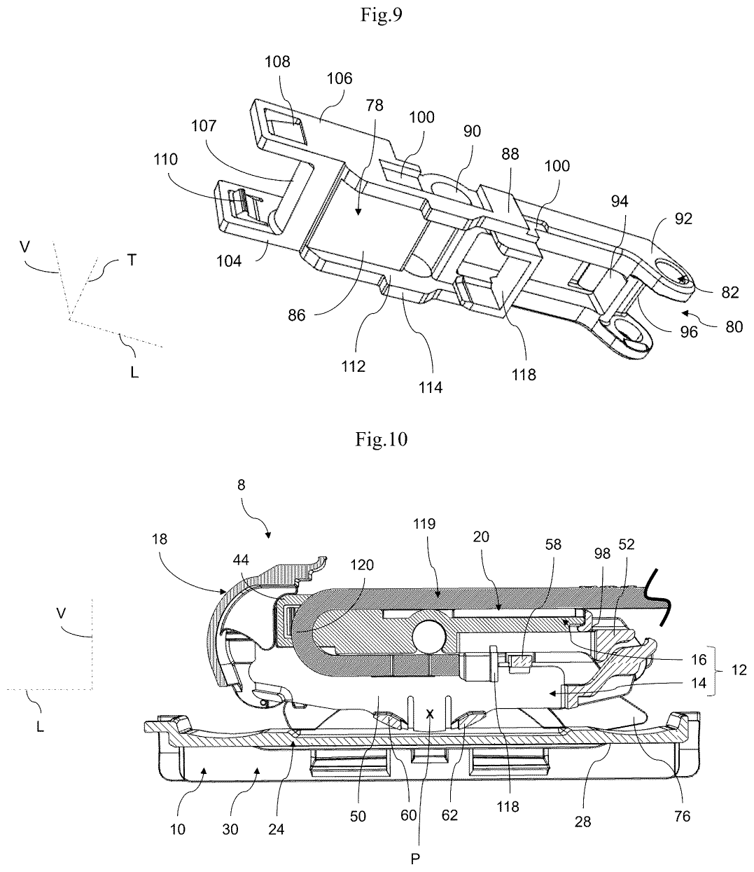

The rotary platform 16 will now be described in more detail with particular reference to FIG. 2, FIG. 3, FIG. 4, FIG. 8 and FIG. 9.

The body 78 generally takes the form of a wall extending mainly in a plane parallel to the longitudinal L and transverse T directions. The body 78 offers an upper surface 84, intended to be facing the wiper arm intended to be attached to the connection device, a lower surface 86 intended to be facing the base 14, and two lateral flanks 88.

The rotary platform 16 comprises a bore 90 intended to form a bearing for receiving a rod of a wiper arm, the bore extending transversely in the body 78 and being open on at least one of the lateral flanks 88. Note in this case that the wiper arm is mounted transversely on the connection device 8, the arm being housed in the bore 90 forming a receiving bearing, which helps to rigidly secure the connection device 8 to the wiper arm.

The abovementioned rotation element 82 is in particular configured to interact with the rotation member 40 of the base 14 so that it can cause the rotational movement of the rotary platform 16 between the first working position and the second mounting position as described above. The rotation element 82 in this case comprises two rotation lugs 92, each comprising a hole passing transversely through the rotation lug 92 and configured to interact with one of the bearing surfaces of the rotation member 40 of the base 14. Rotation lug 92 means a shape distinguished from the lateral flanks 88 firstly by a vertical extension toward the base 14 and secondly by a longitudinal extension of these lateral flanks 88 in the direction away from the free end 44 of the rotary platform 16.

As a variant, at least one of the lateral flanks 88 of the rotary platform 16 comprises a retention means (not shown) for retaining a protruding element formed on a yoke of a type of wiper arm and more particularly a protruding element formed on an internal face of a yoke of a type of wiper arm. The retention means is arranged between the pivot axis and the rotation axis, preferably in the vicinity of the pivot axis.

According to this variant, the retention means comprises at least two walls configured to retain the protruding element of the yoke of a type of wiper arm or a slot configured to receive the protruding element of the yoke of a type of wiper arm.

According to the invention and as can be seen more particularly in FIG. 8 or FIG. 9, the rotary platform 16 comprises a guide wall 94 extending in a plane parallel to and distinct from the longitudinal and transverse plane in which the upper surface 84 of the body 78 extends between the rotation lugs 92 of the rotation element 82. In other words, the guide wall forms a vertical break relative to the upper surface 84 of the body 78.

The guide wall 94 has a stop edge 96 adapted to come into contact with the rotation limiting means 74 of the base 14, when the rotary platform 16 is in the second mounting position, to limit the rotation of the rotary platform 16 about the rotation axis R. The stop edge 96 is in particular arranged at the longitudinal end of the rotary platform which is opposite the free end 44, and extends transversely between the rotation lugs 92.

The stop edge 96 is configured to be in contact with the base 14, and in particular with the rotation limiting means 74, when the rotary platform 16 has reached the desired angle of inclination for the second mounting position, namely in this case an angle of inclination α of between 30° and 60°.

As a variant, the rotary platform 16 may further comprise a positioning member (not shown) at one of its longitudinal ends, configured to bear on the connector 10 when the rotary platform 16 is in the second mounting position in such a way as to position the connection module 12 in an angular position suitable for mounting a type of wiper arm.

More particularly, the positioning member extends longitudinally from the longitudinal end of the rotary platform 16 which is arranged in the vicinity of the rotation member 40, and opposite its free end 44.

This positioning member facilitates and thus ensures the mounting of a type of wiper arm on the rotary platform of the connection module.

When the rotary platform 16 is in the second mounting position, the positioning member bears on the connector 10, creating a force which in turn pivots the base 14 forward.

For example, this positioning member takes the form of a prop.

Moreover, the rotary platform 16 is configured to interact with the removable adapter 20 in such a way as to attach the removable adapter 20 to the rotary platform 16. For example, the rotary platform 16 comprises a window 98 formed by the vertical offset between the guide wall 94 and the body 78 of the rotary platform 16, the window 98 being intended to receive a hook of the adapter 20.

Furthermore, the rotary platform 16 comprises at least one attachment area 100 for attaching the removable adapter 20, on the body 78 of the rotary platform 16, the attachment area 100 taking the form of an indent arranged on the lateral flank 88 of the body 78. Preferably, the rotary platform 16 comprises a pair of attachment areas 100 arranged on either side of a median plane of the rotary platform perpendicular to the rotation axis R. These attachment areas are sized to receive elastically deformable means on board the removable adapter.

In the example illustrated, the rotary platform 16 comprises two attachment areas 100 for attaching the adapter 20, arranged on the same lateral flank 88 of the body 78, in order to keep the removable adapter on the rotary platform.

As shown in FIG. 8 or FIG. 9, the free end 44 of the rotary platform 16 comprises a first flank 104 extending one of the lateral flanks 88 in the direction away from the rotation element 82 and a second flank 106 extending the other lateral flank 88 in the direction away from the rotation element 82 and parallel to the first flank 104, the first flank 104 and the second flank 106 defining a housing for receiving a type of wiper arm, in particular a wiper arm with a hook.

To this end, at least one of the first and/or second flanks 104, 106 comprises an elastically deformable tab 108 having a finger 110 extending into the housing for receiving the wiper arm, the elastically deformable tab 108 being surrounded by a slit formed in the corresponding flank 104, 106. The initial shape of the tab 108 and its elastically deformable nature make it possible to ensure on the one hand that the wiper arm penetrates into the receiving housing between the flanks and on the other hand that each of the fingers 110 is in contact with the wiper arm when the latter is in place in the receiving housing.

In addition, the first and second flanks 104, 106 flank a receiving portion 107 of the rotary platform 16 intended to receive a portion of a hook of a type of arm, the receiving portion 107 having for example a curved profile.

Furthermore, at least one of the lateral flanks 88 comprises a bearing member 112 forming a protrusion on the edge between the lower surface 86 and this lateral flank, in such a way as to form a bearing edge 114 facing the base 14, this bearing edge 114 being intended to bear on the upper edge of the longitudinal wall 50 of the base 14, at the notch 56, when the rotary platform 16 is in the first working position.

As can be seen in FIG. 3, which shows this working position of the rotary platform 16, the specific shapes of the bearing member 112 and of the notch 56 help to define an opening 116 helping to block in position a particular type of wiper arm relative to the connection module 12, this particular type of wiper arm comprising an attachment element adapted to be housed in the opening 116 which is closed when the rotary platform is folded down against the base and makes it possible to trap the attachment element of the wiper arm.

Thus, the platform and the base are configured such that the platform is at least partially disengaged from the base in the working position, which in particular makes it possible to make available surfaces for attaching the removable adapter or the covering member, in addition to providing, as has just been mentioned, additional means for attaching a wiper arm between the base and the rotary platform, the rotation of the platform into its working position making it possible to grip and lock a wiper arm attachment element between the platform and the base.

As can be seen in particular in FIG. 9, the rotary platform 16 comprises a reinforcing element 118 extending from the lower surface 86 of the body 78 toward the base 14, the reinforcing element 118 having a U-shaped section seen in a plane parallel to the longitudinal direction and to the rotation axis R. This reinforcing element 118 makes it possible on the one hand to guide the rotation of the rotary platform 16 about the rotation axis R when the rotary platform 16 goes in particular from the second mounting position to the first working position, by being inserted between the longitudinal walls 50 of the base. This reinforcing element also makes it possible to form a stop means for a type of wiper arm, in particular arms with a hook which have been positioned around the receiving portion 107 mentioned above, the reinforcing element being able to form a longitudinal stop for an arm with a hook of a first dimension or a vertical stop for an arm with a hook of a second dimension.

It is understood from the above that the connector 10, the base 14 and the rotary platform 16 interact with one another such that the connection device 8 can take up a mounting position, during which the rotary platform 16 is in the second mounting position, and a working position during which the rotary platform 16 is in the first working position. And as mentioned above, the rotary platform may be arranged, in the mounting position, with optimal angular separation within a reduced bulk.

By virtue of this mobility of the components of the connection device 8, in particular the base 14 and the rotary platform 16, and their dimensions, in particular longitudinal, different types of wiper arm can be mounted on the connection device 8.

As shown in FIG. 10, one type of wiper arm 119 may include a hook 120, the latter extending at least partially into the receiving housing defined at least partially by the first and second flanks 104, 106 of the rotary platform 16. Note in this case that, to mount the connection device 8 on the hook 120 of the arm 119, the rotary platform 16 is positioned beforehand in the second mounting position, by rotation about the rotation axis R, in such a way as to disengage the free end 44 of the rotary platform and in particular the receiving portion 107 formed between the two flanks 104, 106. The end of the hook 120 is slipped under the rotary platform 16, facing the lower surface 86 of the body 78, and the hook is brought back toward the platform until the hook abuts against the receiving portion 107 and the end of the hook is in contact with the guide element 118. In this movement, the wiper arm first pushes out the elastic tabs 108 and the fingers 110 formed on the flanks 104, 106 of the free end of the rotary platform 16. The wiper arm with a hook 120 is held in position against the rotary platform by the elastic return to position of the fingers 110 which tends to press the hook against the receiving portion. The position of the arm relative to the connection device is then secured and locked by folding down the rotary platform against the base.

As shown in FIG. 11, a type of wiper arm 121 may be mounted laterally on the connection device, and for this purpose it comprises a transverse rod intended to interact with the bore 90 of the rotary platform 16. In this configuration, the interaction between the bore 90 of the rotary platform 16 and the rod of the arm 121 makes it possible to fix the longitudinal and vertical position of the wiper arm relative to the connection device 8. Furthermore, this type of wiper arm 121 comprises a retention tab 122, adapted to cover the upper surface 84 of the body, and more particularly in this case an upper surface 21 of the removable adapter 20, at the free end of which a retention finger makes it possible to block the transverse position of the wiper arm 121 relative to the connection device 8. The type of wiper arm type 121 with a transverse rod is mounted while the rotary platform 16 is locked on the base, in the first working position.

These two examples illustrate an advantage of a connection module comprising a base and a rotary platform, the two types of arm being mounted on the connection device with the rotary platform in positions which are different in each case. Furthermore, the rotary platform 16 makes it possible, in the example illustrated in FIG. 11, to add the removable adapter 20, which has studs adapted to fixing the position of the retention tab 122.

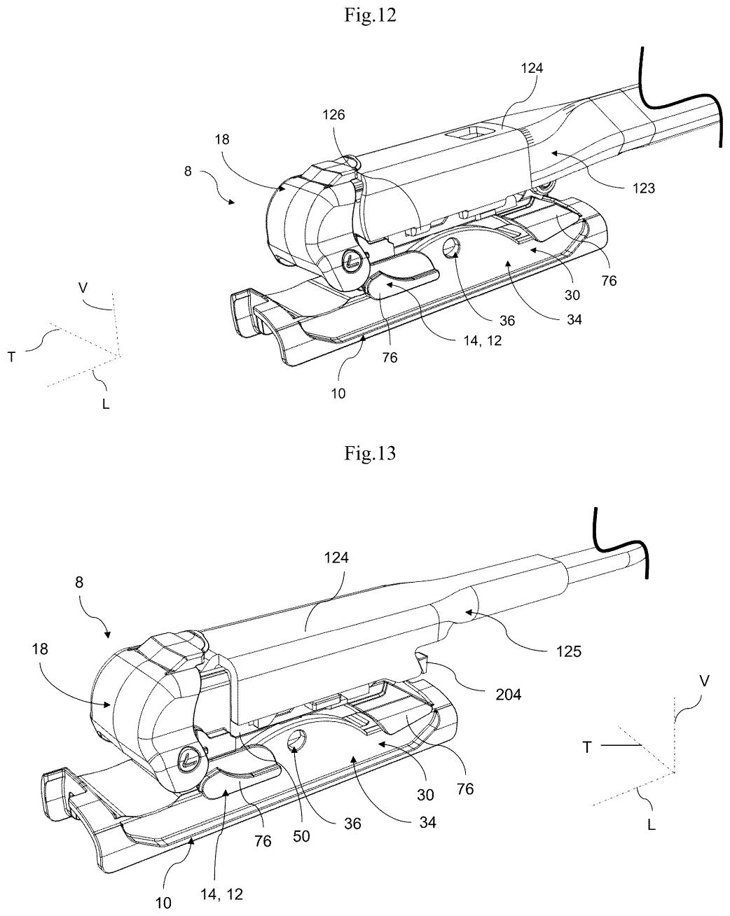

As shown in FIG. 12, one type of wiper arm 123 comprises a yoke 124 at least partially covering the connection module 12, the arm 123 comprising at least one attachment element 126 which is trapped in the opening delimited by the bearing member 112 of the rotary platform 16 and the notch 56 of the base 14 when the rotary platform 16 is folded down against the base 14. Note in this case that, to mount the connection device 8 on the type of wiper arm 123, the rotary platform 16 is positioned beforehand in the second mounting position, by rotation about the rotation axis R, in such a way as to be able to insert the attachment element 126 in the opening without forcing this attachment element and weakening it. The rotary platform 16 is then folded down against the base 14, by rotation about the rotation axis R, so as to close up the opening and trap the attachment element.

It is thus clear that the mobility of the rotary platform relative to the base can make it possible to generate specific attachment means for certain arms formed partly on the base 14 and partly on the rotary platform 16, the rotation of the rotary platform 16 making it possible to trap an element of the wiper arm in these specific attachment means when the rotary platform 16 is folded down against the base 14.

Another type of wiper arm 125, also comprising a yoke 124 adapted to at least partially cover the connection module 12, is shown in FIG. 13. A free end of the yoke 124 is covered by the cap 18 in its covering position, in order to vertically block the yoke 124 relative to the connection device 8 and the yoke 124 rests at its opposite end against the at least one locking tab 204 of the removable adapter 20.

This type of wiper arm 125 may be mounted on the connection device with a rotary platform 16 which is both in its first working position and in its second mounting position, as long as the cap is pivoted to take up its release position. Once the wiper arm is in contact with the locking tab 204 of the removable adapter 20, the cap may be folded down to trap the free end of the yoke 124.

The various examples illustrated here in FIG. 10 to FIG. 13 clearly show that the connection device 8 according to the invention adapts to different types of wiper arm, thus making it possible to rigidly secure the wiper blade 2 mounted on the connection device 8 to a wide variety of types of wiper arm.

The present invention is not however limited to the means and configurations described and illustrated in the present document, and also extends to all equivalent means and configurations and to any technically operational combination of such means.

What is claimed is:

1. A connection module configured to be mounted pivotably about a pivot axis of a connector configured to be rigidly secured to a wiper blade extending in a longitudinal direction, the connection module being adapted to be connected to a wiper arm, the connection module comprising at least one base mounted pivotably on the connector and a rotary platform mounted rotatably about a rotation axis on the base, the pivot axis and the rotation axis extending parallel to and separately from one another, the rotation axis being offset longitudinally relative to the pivot axis, wherein the rotary platform has a longitudinal dimension substantially equal to the longitudinal dimension of the base.

2. The connection module as claimed in claim 1, wherein the rotation axis is formed at one of the longitudinal ends of the base.

3. The connection module as claimed in claim 1, wherein the base includes a rotation member adapted to interact with the rotary platform and a guide block intended to receive a free end of the rotary platform, the base extending longitudinally while having a first longitudinal end in the vicinity of which the guide block is arranged and a second longitudinal end in the vicinity of which the rotation member is arranged.

4. The connection module as claimed in claim 1, wherein the rotary platform is movable between a first working position in which the rotary platform is received in the guide block of the base and a second mounting position in which the free end of the rotary platform is arranged at a distance from the guide block.

5. The connection module as claimed in claim 3 wherein the base includes a frame including at least two longitudinal walls extending in the longitudinal direction between the first longitudinal and the second longitudinal end parallel to one another, the frame further including two transverse walls extending perpendicularly and between the longitudinal walls, a first transverse wall being arranged at the first longitudinal end of the structure and facing the guide block while the second transverse wall is arranged at the second longitudinal end and bears the rotation member.

6. The connection module as claimed in claim 5, wherein the guide block includes two lateral segments extending parallel to one another each from one of the longitudinal walls opposite the connector, and wherein the guide block includes at least one recess formed on an internal face of one of the lateral segments and adapted to interact with the rotary platform.

7. The connection module as claimed in claim 5, wherein the base includes at least one protrusion arranged at the second longitudinal end of the base, the protrusion protruding from the first transverse wall in the opposite direction to the connector, the rotation member taking the form of a shaft carried by the protrusion and extending transversely beyond the protrusion.

8. The connection module as claimed in claim 3, wherein the rotary platform includes a body extending in the longitudinal direction between a free end configured to interact with the guide block and a longitudinal edge on which there is a rotation element for rotation of the rotary platform about the rotation axis.

9. The connection module as claimed in claim 8, wherein the free end of the rotary platform includes a first flank extending a lateral flank of the body in the direction away from the rotation element and a second flank extending the other lateral flank of the body in the direction away from the rotation element, parallel to the first flank, the first flank and the second flank defining a housing for receiving an arm.

10. The connection module as claimed in claim 9, wherein at least one of the first and/or second flanks includes an elastically deformable tab having a finger extending into the housing for receiving the arm.

11. A connection device for connecting a wiper blade extending in a longitudinal direction to a wiper arm of a wiping system, the connection device comprising a connector configured to be rigidly secured to the wiper blade and a connection module adapted to be mounted on the connector and connected to the wiper arm, the connection module including at least one base mounted pivotably about a pivot axis on the connector and a rotary platform mounted rotatably about a rotation axis on the base, the pivot axis and the rotation axis extending parallel to and separately from one another, the rotation axis being offset longitudinally relative to the pivot axis, wherein the rotary platform has a longitudinal dimension substantially equal to the longitudinal dimension of the base.
